(19) United States
(12) Patent Application Publication
(10) Pub. No.: US 2023/0173645 A1
(43) Pub. Date: Jun. 8, 2023

(54) VITRIFIED BOND GRINDSTONE

(71) Applicant: DISCO CORPORATION, Tokyo (JP)

(72) Inventors: Hirotoshi HOSHIKAWA, Tokyo (JP); Yoshiyasu NAKAGAWA, Tokyo (JP)

(21) Appl. No.: 18/056,772

(22) Filed: Nov. 18, 2022

(30) Foreign Application Priority Data
Dec. 6, 2021 (JP) 2021-197508

(51) Int. Cl. B24D 3/10; C03C 14/00

(52) U.S. Cl. CPC B24D 3/10; C03C 14/004; C03C 2214/04; C03C 2214/30

(57) ABSTRACT

A vitrified bond grindstone includes abrasive grains and a bonding material for fixing the abrasive grains, the bonding material includes a parent material containing SiO₂ as a main constituent, a sintering assistant oxide, and ZnO, and the content of ZnO is 11 to 15 wt % in weight ratio based on the bonding material. Preferably, the content of the sintering assistant oxide is 20 to 29 wt % in weight ratio based on the bonding material.

### BACKGROUND OF THE INVENTION

### Field of the Invention

The present invention relates to a vitrified bond grindstone used by being mounted to a grinding wheel or the like that is included in a grinding apparatus for grinding a workpiece.

### Description of the Related Art

Device chips used for such electronic apparatuses as mobile phones and personal computers are manufactured from a wafer formed of a semiconductor material such as silicon. When a plurality of devices are formed on a front surface of the wafer, a back surface of the wafer is ground to be thinned to a predetermined thickness, and thereafter the wafer is divided for each device, so that individual device chips including such devices as integrated circuits (ICs) and large scale integration circuits (LSIs) are manufactured.

A grinding apparatus is used for the grinding of the back surface of the wafer (see, for example, Japanese Patent Laid-open No. 2000-288881). The grinding apparatus includes an annular grinding wheel and a spindle that supports the grinding wheel in a rotatable manner. The grinding wheel includes an annular wheel base and grindstones provided in an annular pattern on one surface of the wheel base. As the grindstone to be mounted to the grinding wheel, particularly, a grindstone called a vitrified bond grindstone is widely used. The vitrified bond grindstone is formed by a bonding material (a mixture of silicon dioxide (SiO₂), aluminum oxide (Al₂O₃), and boron oxide (B₂O₃)) containing a vitreous material as a main constituent being mixed with abrasive grains and the mixed material being sintered. Since the sintering temperature in this instance is a high temperature on the order of 1,200° C. to 1,300° C., the abrasive grains contained in the grindstone are liable to be deteriorated through carbonization or the like. When grinding is conducted by use of the grindstone in which the abrasive grains have been deteriorated, the grindstone cannot exhibit an expected performance.

In addition, when a workpiece is ground by the grinding wheel to which the grindstones are mounted, typically, there occurs shelf-sharpening in which the bonding material is consumed appropriately and unused abrasive grains contained in the grindstone appear one after another from the bonding material. Hence, the grinding ability of the grindstone is maintained at a certain level. However, the vitrified bond grindstone having the bonding material containing a vitreous material as a main constituent is very hard and is consumed very little, so that self-sharpening is not liable to occur sufficiently, and the grinding ability is not easily maintained at a certain level. In view of this, to make the grindstone brittle and self-sharpening liable to occur and thereby prevent deterioration of the abrasive grains, a technology of further adding sintering assistant oxides to the material of the vitrified bond grindstone and lowering the sintering temperature is carried out. When the sintering temperature of the vitrified bond grindstone is lowered, the bonding material is consumed appropriately, and self-sharpening of the grindstone is liable to occur. Note that examples of the sintering assistant oxides include sodium oxide (Na₂O), calcium oxide (CaO), potassium oxide (K₂O), barium oxide (BaO), and lithium oxide (Li₂O).

### SUMMARY OF THE INVENTION

However, these sintering assistant oxides are highly soluble in water, so that the vitrified bond grindstone manufactured through addition of sintering assistant oxides and sintering is liable to be low in water resistance and strength, which is a problem. Since grinding water is supplied to the grinding wheel and the workpiece and a large force is exerted on the grindstone during grinding of the workpiece, the vitrified bond grindstone low in water resistance and strength has a problem when put to practical use.

Accordingly, it is an object of the present invention to provide a vitrified bond grindstone which can be manufactured at a low sintering temperature and which has water resistance and strength of or above certain levels.

In accordance with an aspect of the present invention, there is provided a vitrified bond grindstone including abrasive grains and a bonding material for fixing the abrasive grains, in which the bonding material includes a parent material containing SiO₂ as a main constituent, a sintering assistant oxide, and zinc oxide (ZnO), and the content of ZnO is 11 to 15 wt % in weight ratio based on the bonding material.

Note that, preferably, the content of the sintering assistant oxide is 20 to 29 wt % in weight ratio based on the bonding material.

In addition, preferably, the sintering assistant oxide includes at least one of Na₂O, CaO, K₂O, and BaO.

Further, preferably, the bonding material contains zirconium dioxide (ZrO₂) in a content of 3 to 5 wt % in weight ratio based on the bonding material.

The vitrified bond grindstone according to a mode of the present invention includes abrasive grains and a bonding material. The bonding material includes a parent material containing SiO₂ as a main constituent, a sintering assistant oxide, and ZnO. The content of ZnO is 11 to 15 wt % in weight ratio based on the bonding material. The bonding material containing ZnO in a content of 11 to 15 wt % has sufficient water resistance, is capable of suppressing the sintering temperature to a relatively low temperature, has such strength as to be able to endure grinding, and is not so hard that progress of self-sharpening is hindered.

Therefore, according to a mode of the present invention, there is provided a vitrified bond grindstone which can be manufactured at a low sintering temperature and which has water resistance and strength of or above certain levels.

The above and other objects, features and advantages of the present invention and the manner of realizing them will become more apparent, and the invention itself will best be understood from a study of the following description and appended claims with reference to the attached drawings showing a preferred embodiment of the invention.

### BRIEF DESCRIPTION OF THE DRAWINGS

FIG. 1 is a perspective view schematically depicting the structure of a grinding wheel; and

FIG. 2 is a side view schematically depicting a workpiece to be ground by a grinding apparatus.

### DETAILED DESCRIPTION OF THE PREFERRED EMBODIMENT

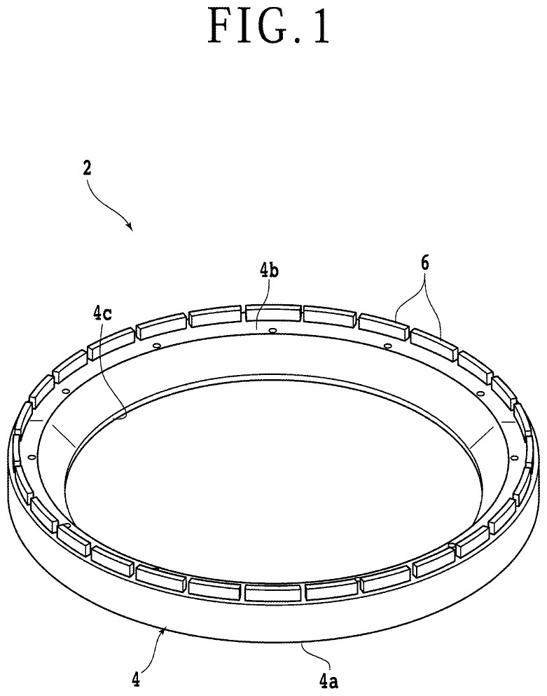

An embodiment of the present invention will be described in detail below with reference to the attached drawings. FIG. 1 is a perspective view schematically depicting the structure of a grinding wheel 2 to which vitrified bond grindstones 6 according to the present embodiment are mounted. As depicted in FIG. 1, the grinding wheel 2 includes a disk-shaped (annular) wheel base 4 formed of stainless steel, aluminum, or the like. The wheel base 4 has a first surface 4a and a second surface 4b which are parallel to each other, and is formed in the center thereof with a circular opening 4c which penetrates the wheel base 4 from the first surface 4a to the second surface 4b. A plurality of vitrified bond grindstones 6 according to the present embodiment are arranged in an annular pattern on the second surface 4b of the wheel base 4.

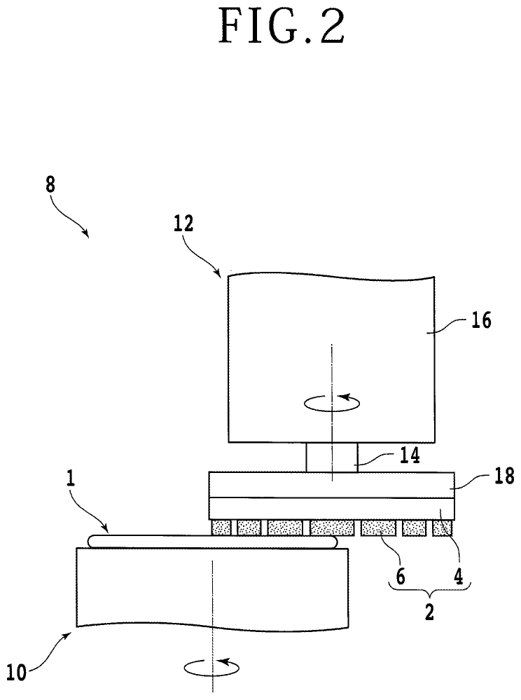

The grinding wheel 2 is used in the state of being incorporated in a grinding unit of a grinding apparatus. FIG. 2 is a side view schematically depicting a workpiece 1 to be ground by a grinding apparatus 8. The workpiece 1 is typically a semiconductor wafer, a resin substrate, a ceramic substrate, or the like, but the workpiece 1 is not limited to this.

The grinding apparatus 8 includes a chuck table 10 capable of holding under suction the workpiece 1 and a grinding unit 12 that grinds the workpiece 1 held by the chuck table 10. The chuck table 10 is connected to an unillustrated suction source and causes a negative pressure generated in the suction source to act on the workpiece 1 placed on an upper surface of the chuck table 10, thereby holding under suction the workpiece 1. In addition, the chuck table 10 can be rotated around a rotational axis which is substantially perpendicular to the upper surface thereof by an unillustrated rotational drive source. The grinding unit 12 includes a spindle 14 extending along a direction substantially perpendicular to the upper surface of the chuck table 10, a rotational drive source 16 such as a motor connected to an upper end of the spindle 14 for rotating the spindle 14, and a wheel mount connected to a lower end of the spindle 14. The grinding wheel 2 is fixed to the wheel mount 18 in a state in which the first surface 4a of the wheel base 4 is in contact with a lower surface of the wheel mount 18. Accordingly, the second surface 4b of the wheel base 4 to which the vitrified bond grindstones 6 are mounted is directed toward the upper surface of the chuck table 10.

The chuck table 10 holding under suction the workpiece 1 is rotated around a rotational axis perpendicular to the upper surface thereof, and the rotational drive source 16 is operated to rotate the spindle 14, thereby moving the vitrified bond grindstones 6 on an annular orbit and lowering the grinding unit 12. Then, the vitrified bond grindstones 6 come into contact with the workpiece 1, whereby the workpiece 1 is ground. The grinding unit 12 is lowered until the workpiece 1 has a predetermined thickness, and then, the grinding of the workpiece 1 is ended. When the workpiece 1 is ground by the vitrified bond grindstones 6, grinding swarf and heat are generated from the workpiece 1 and the vitrified bond grindstones 6. In view of this, during grinding of the workpiece 1, grinding water such as pure water is supplied from an unillustrated grinding water supply nozzle to the upper surface of the workpiece 1 and the grinding wheel 2, whereby the grinding swarf and the heat are removed by the grinding water. Due to such a circumstance, the vitrified bond grindstones 6 need water resistance of or above a certain level.

The vitrified bond grindstones 6 according to the present embodiment include a bonding material and innumerable abrasive grains dispersed and fixed in the bonding material. The abrasive grains are formed of, for example, diamond, cubic boron nitride (CBN), or the like. Note that in regard of the abrasive grains, the material, average grain diameter, content in the bonding material, and the like can appropriately be selected according to the specifications of the vitrified bond grindstones 6 and the like. When the vitrified bond grindstones 6 are brought into contact with the workpiece 1, the workpiece 1 is ground by the abrasive grains, and the abrasive grains are gradually consumed. In this instance, the bonding material is also gradually consumed, so that new abrasive grains appear one after another. Thus, the grinding ability of the vitrified bond grindstones 6 is kept at a certain level. This action is called self-sharpening. It is to be noted, however, that, if the bonding material is too hard, consumption thereof is not liable to occur, self-sharpening does not proceed suitably, and the grinding ability of the vitrified bond grindstones 6 would be lowered. On the other hand, if the bonding material is too low in strength, the workpiece 1 cannot be ground suitably. Hence, the bonding material needs to have appropriate hardness and strength.

At the time of manufacturing the vitrified bond grindstones 6, abrasive grains are mixed into a member which is the material of the bonding material, and the mixture is molded and sintered at high temperature. The temperature suitable for the sintering in this instance varies according to the configuration of the member which is the material of the bonding material. Since the abrasive grains would be carbonized and deteriorated during sintering if the sintering temperature of the bonding material is too high, it is preferable that the bonding material be capable of being sintered at a low temperature.

The bonding material of the vitrified bond grindstones 6 includes a parent material which contains SiO₂ as a main constituent. The bonding material may further include B₂O₃ and Al₂O₃ as parent materials for forming a vitrified material. It is to be noted, however, that the sintering temperature of the bonding material including only a parent material containing SiO₂, Al₂O₃, and B₂O₃ as main constituents is a high temperature on the order of 1,200° C. to 1,300° C. If the vitrified bond grindstones 6 are sintered at this temperature, the abrasive grains dispersed in the bonding material would be deteriorated. In view of this, a sintering assistant oxide for lowering the sintering temperature is mixed into the member which is the material of the bonding material. The sintering assistant oxide includes, for example, at least one of Na₂O, CaO, K₂O, and BaO. The content of the sintering assistant oxide is preferably 20 to 29 wt % in weight ratio based on the bonding material. When the sintering assistant oxide is added to the bonding material, the sintering temperature is lowered, so that the abrasive grains are not liable to be deteriorated during sintering.

However, the vitrified bond grindstones 6 including the bonding material with such a sintering assistant oxide added thereto tend to be lowered in mechanical strength and also in water resistance. At the time of grinding the workpiece 1, a large force is exerted on the vitrified bond grindstones mounted to the grinding wheel 2. Besides, during grinding, the grinding liquid including water is supplied to the workpiece 1 and the like. Hence, when the grinding is conducted with the vitrified bond grindstones 6 which are low in mechanical strength and water resistance, damage to the vitrified bond grindstones 6 is liable to occur, which is a problem. In view of this, in the vitrified bond grindstones 6 according to the present embodiment, it is preferable that ZnO which dissolves very little in water be mixed into the bonding material in a predetermined content. Particularly, when the content of ZnO is 11 to 15 wt % in weight ratio based on the bonding material, the sintering temperature is suppressed to a relatively low value, and the vitrified bond grindstones 6 have water resistance and mechanical strength of or above predetermined levels.

Thus, the vitrified bond grindstones 6 according to the present embodiment maintain sufficient mechanical strength and water resistance, while the sintering temperature is low and appropriate consumption occurs during grinding, so that the vitrified bond grindstones 6 have such a performance suitable for grinding. Further, ZrO₂ may be mixed into the bonding material together with ZnO in a predetermined content. Particularly, when the content of ZrO₂ is 3 to 5 wt % in weight ratio based on the bonding material, the water resistance and mechanical strength of the bonding material become more favorable.

### EXAMPLES

In the present examples, vitrified bond grindstones 6 having the bonding material including the parent material containing SiO₂ as a main constituent, sintering assistant oxides, and ZnO were produced, and the water resistance, mechanical strength, and sintering temperature during manufacturing thereof were evaluated. In the present examples, a plurality of vitrified bond grindstones 6 differing in the blending ratio of the constituents of the bonding material were produced, and these values were evaluated for respective ones of them. Here, the content of ZnO contained in the bonding material was set to be 11 to 15 wt % in weight ratio based on the bonding material. In addition, for comparison, vitrified bond grindstones 6 in which the content of ZnO in the bonding material is not within this range were produced, and water resistance and the like were evaluated similarly.

As materials for the vitrified bond grindstones 6, a parent material containing SiO₂ as a main constituent, sintering assistant oxides, and ZnO were prepared in predetermined amounts. These materials were mixed by a predetermined method, and the mixed material was molded by being put in a mold, followed by sintering at a required temperature to produce the vitrified bond grindstones 6. The names of the vitrified bond grindstones 6 and the weight ratios (wt %) of the materials contained in the bonding material are set forth in Table 1 below. Here, the names of the vitrified bond grindstones 6 in which the content of ZnO in the bonding material is within the range of 11 to 15 wt % in weight ratio based on the bonding material include “Example,” whereas the names of the vitrified bond grindstones 6 in which the content of ZnO is outside of the range include “Comparative Example.” Note that in Table 1, some of the constituent materials of the bonding material in the vitrified bond grindstones 6 and the weight ratios thereof are omitted. For this reason, even when all the weight ratios of the parent material, added oxides, and sintering assistance oxides that are set forth in Table 1 are summed up, the result may not necessarily be 100 wt %.

TABLE 1

| | Parent | | | | Sintering assistant oxides | | | | | | |
|---|---|---|---|---|---|---|---|---|---|---|---|
| | material | Added oxides | | | | | | | | | Total |
| Name | SiO₂ | ZnO | ZrO₂ | TiO | MgO | CaO | Na₂O | K₂O | BaO | Li₂O | amount |
| Example 1 | 42.1 | 11.7 | 3.0 | 0.0 | 0.0 | 10.0 | 4.6 | 1.9 | 4.2 | 0.0 | 20.7 |
| Example 2 | 42.0 | 12.0 | 3.0 | 0.0 | 0.0 | 0.0 | 0.0 | 16.0 | 10.0 | 0.0 | 26.0 |
| Example 3 | 42.0 | 12.0 | 3.0 | 0.0 | 0.0 | 5.0 | 0.0 | 16.0 | 0.0 | 0.0 | 21.0 |
| Example 4 | 32.0 | 12.0 | 5.0 | 0.0 | 0.0 | 13.0 | 0.0 | 16.0 | 0.0 | 0.0 | 29.0 |
| Example 5 | 36.0 | 12.0 | 5.0 | 0.0 | 0.0 | 7.0 | 2.0 | 16.0 | 0.0 | 0.0 | 25.0 |
| Example 6 | 37.0 | 12.0 | 5.0 | 0.0 | 0.0 | 15.0 | 5.0 | 2.0 | 2.0 | 0.0 | 24.0 |
| Example 7 | 35.0 | 12.0 | 5.0 | 0.0 | 0.0 | 15.0 | 5.0 | 2.0 | 4.0 | 0.0 | 26.0 |
| Example 8 | 33.0 | 12.0 | 5.0 | 0.0 | 0.0 | 15.0 | 5.0 | 2.0 | 6.0 | 0.0 | 28.0 |
| Comparative | 56.5 | 8.4 | 0.0 | 0.0 | 0.0 | 5.2 | 6.8 | 1.2 | 0.0 | 0.0 | 13.2 |
| Example 1 | | | | | | | | | | | |
| Comparative | 59.0 | 9.0 | 1.0 | 1.0 | 1.0 | 9.0 | 2.0 | 4.0 | 1.0 | 2.0 | 19.0 |
| Example 2 | | | | | | | | | | | |
| Comparative | 50.9 | 9.6 | 11.0 | 0.0 | 0.0 | 5.8 | 4.2 | 3.2 | 0.0 | 0.0 | 13.2 |
| Example 3 | | | | | | | | | | | |
| Comparative | 52.0 | 7.0 | 10.0 | 0.0 | 5.0 | 7.0 | 0.0 | 6.0 | 0.0 | 0.0 | 18.0 |
| Example 4 | | | | | | | | | | | |
| Comparative | 57.0 | 3.1 | 2.1 | 0.0 | 0.0 | 6.7 | 1.2 | 4.4 | 10.9 | 0.0 | 23.2 |
| Example 5 | | | | | | | | | | | |
| Comparative | 54.0 | 17.0 | 1.0 | 0.0 | 0.0 | 13.0 | 1.0 | 3.0 | 2.0 | 0.0 | 19.0 |
| Example 6 | | | | | | | | | | | |
| Comparative | 50.0 | 10.0 | 0.0 | 0.0 | 0.0 | 10.0 | 0.0 | 20.0 | 0.0 | 0.0 | 30.0 |
| Example 7 | | | | | | | | | | | |

Next, as an evaluation test of the mechanical strength of the vitrified bond grindstones 6 produced, a transverse strength test was performed. For the transverse strength test, a transverse strength measuring device “AGI-1 kN” made by SHIMADZU CORPORATION was used. While the pressurization speed was set to 1 mm/min and the load capacity to 0 to 1 kN, the vitrified bond grindstones 6 produced were pressed, and the pressure value at the time of breakage was recorded as the transverse strength. Then, relative values of transverse strength of the vitrified bond grindstones 6 when the transverse strength of the vitrified bond grindstone 6 according to Comparative Example 1 was taken as 100 were calculated. The relative values of transverse strength of the vitrified bond grindstones 6 are set forth in Table 2 below.

In addition, an evaluation test of water resistance of the vitrified bond grindstones 6 produced was conducted. In the evaluation test of water resistance, each vitrified bond grindstone 6 was immersed in hot water for five hours, and weight measurement was conducted before and after the immersion. Note that the hot water was used in the present test, in consideration of the vitrified bond grindstone being heated by the heat generated by grinding, and for setting the test environment close to the environment during grinding.

First, for each vitrified bond grindstone 6, the weight was measured before immersion in hot water. Next, after immersion in the hot water for five hours, the vitrified bond grindstone 6 was dried, and the weight thereof was again measured. Then, a value obtained by dividing the weight before immersion of the vitrified bond grindstone 6 in hot water by the weight after the immersion was calculated as a degree of solubility. Then, relative values of solubility of the vitrified bond grindstones 6 according to Examples when the solubility of the vitrified bond grindstone 6 according to Comparative Example 1 was taken as 100 were calculated. As the relative value of solubility is smaller, the solubility in grinding water is lower, and water resistance is higher. In other words, the relative value is a lower value as the weight change of the vitrified bond grindstones 6 is smaller and as the water resistance is higher. The relative values of solubility of the vitrified bond grindstones 6 according to Examples are set forth in Table 2 below. In addition, the temperature required for sintering each vitrified bond grindstone 6 is described in Table 2 as the sintering temperature.

TABLE 2

| | | Relative value of | Relative value |
|---|---|---|---|
| | Sintering | transverse | of water |
| Name | temperature | strength | resistance |
| Example 1 | 750° C. | 152.2 | 47.4 |
| Example 2 | 750° C. | 139. 0 | 33.9 |
| Example 3 | 750° C. | 121.6 | 10.4 |
| Example 4 | 750° C. | 128.5 | 30.1 |
| Example 5 | 750° C. | 209.0 | 43.1 |
| Example 6 | 750° C. | 135.1 | 46.6 |
| Example 7 | 750° C. | 125.1 | 49.5 |
| Example 8 | 750° C. | 142.1 | 52.4 |
| Comparative | 700° C. | 100.0 | 100.0 |
| Example 1 | | | |
| Comparative | 740° C. | 36.0 | 205.0 |
| Example 2 | | | |
| Comparative | 800° C. | 220.0 | 17.0 |
| Example 3 | | | |
| Comparative | 900° C. | 159.0 | 7.0 |
| Example 4 | | | |
| Comparative | 820° C. | 198.0 | 52.0 |
| Example 5 | | | |
| Comparative | 900° C. | 52.0 | 21.0 |
| Example 6 | | | |
| Comparative | 800° C. | 134.9 | 364.7 |
| Example 7 | | | |

It is desired that the sintering temperature of the vitrified bond grindstones 6 be equal to or lower than 780° C. When the sintering temperature exceeds this temperature, abrasive grains of diamond, silicon carbide (SiC), or the like and a filler and the like dispersed in the material of the bonding material are denatured. It is considered that, since the vitrified bond grindstones 6 according to Comparative Examples 3 to 7 need a sintering temperature of equal to or higher than 800° C., the abrasive grains are denatured and the desired grinding ability cannot be exhibited.

In addition, the mechanical strength that the vitrified bond grindstones 6 should have for processing the workpiece 1 is a relative value of the transverse strength mentioned above in excess of approximately 95. The vitrified bond grindstones 6 having a transverse strength below this value would be broken while deteriorating due to repeated grinding. The relative values of the transverse strength of the vitrified bond grindstones 6 according to Comparative Examples 2 and 6 are below this value, so that they are evaluated not to have the necessary mechanical strength.

Further, the water resistance that the vitrified bond grindstones 6 should have for processing the workpiece 1 is a relative value of water resistance mentioned above of below approximately 55. In the case where the relative value of water resistance is above this value, the bonding material is gradually dissolved in the grinding water supplied, so that the vitrified bond grindstone 6 is denatured, making it difficult to perform suitable grinding before the elapse of one month assumed as the use period. The relative values of water resistance of the vitrified bond grindstones 6 according to Comparative Examples 1, 2, and 7 exceed this value, so that these grindstones are evaluated not to have the required water resistance.

In addition, the vitrified bond grindstones 6 according to Examples 1 to 8 have sintering temperatures lower than 780° C., so that their abrasive grains and the like can exhibit sufficient functions, and they are evaluated to have sufficient mechanical strength and water resistance. Hence, it has been confirmed that when the content of ZnO in the bonding material is 11 to 15 wt % in weight ratio based on the bonding material, the vitrified bond grindstones 6 can be manufactured at low sintering temperatures, and they have water resistance and strength of or above certain levels.

Besides, as understood from the relative value of the transverse strength of the vitrified bond grindstone 6 according to Comparative Example 6, when the content of ZnO is excessive and the content of the sintering assistant oxides is too lowered, the strength of the vitrified bond grindstone 6 is lowered. On the other hand, as understood from the performance evaluation of the vitrified bond grindstone 6 according to Comparative Example 7, when the content of the sintering assistant oxides is too increased, the water resistance of the vitrified bond grindstone 6 is relatively lowered. In view of the above, it is preferable that the content of the sintering assistant oxides be 20 to 29 wt % in weight ratio based on the bonding material.

In addition, as understood from the sintering temperature of the vitrified bond grindstone 6 according to Comparative Example 5, even in the case where the content of the sintering assistant oxides is within this range, the sintering temperature would rather become higher if the content of ZnO is less than the required amount. Hence, it is indispensable that ZnO be contained in the bonding material within the abovementioned content range.

Besides, as understood from the performance evaluation of the vitrified bond grindstone 6 according to Comparative Example 2, the water resistance of the vitrified bond grindstone 6 in which Li₂O is contained in the material of the bonding material can be recognized to be relatively lowered from this comparative example. In addition, as understood from the performance of the vitrified bond grindstone 6 according to Comparative Example 4, the sintering temperature of the bonding material containing magnesium oxide (MgO) is only slightly lowered. In view of this, it is preferable that the bonding material of the vitrified bond grindstones 6 do not contain Li₂O and MgO.

Further, from the results of performance evaluation of the vitrified bond grindstones 6 in the present examples, it is understood that it is preferable that ZrO₂ be contained in the bonding material in a certain content, in addition to ZnO. In other words, preferable is a vitrified bond grindstone 6 in which the bonding material contains ZrO₂ in a content of 3 to 5 wt % in weight ratio based on the bonding material.

The present invention is not limited to the details of the above described preferred embodiment. The scope of the invention is defined by the appended claims and all changes and modifications as fall within the equivalence of the scope of the claims are therefore to be embraced by the invention.

What is claimed is:

1. A vitrified bond grindstone comprising:
abrasive grains; and
a bonding material for fixing the abrasive grains,
wherein the bonding material includes a parent material containing silicon dioxide as a main constituent, a sintering assistant oxide, and zinc oxide, and
a content of zinc oxide is 11 to 15 wt % in weight ratio based on the bonding material.

2. The vitrified bond grindstone according to claim 1, wherein a content of the sintering assistant oxide is 20 to 29 wt % in weight ratio based on the bonding material.

3. The vitrified bond grindstone according to claim 1, wherein the sintering assistant oxide includes at least one of sodium oxide, calcium oxide, potassium oxide, and barium oxide.

4. The vitrified bond grindstone according to claim 1, wherein the bonding material contains zirconium dioxide in a content of 3 to 5 wt % in weight ratio based on the bonding material.
